(19) United States
(12) Patent Application Publication
(10) Pub. No.: US 2024/0275539 A1
(43) Pub. Date: Aug. 15, 2024

(54) INFORMATION CONFIGURATION METHOD AND APPARATUS, NETWORK SIDE DEVICE, AND TERMINAL

(71) Applicant: VIVO MOBILE COMMUNICATION CO., LTD., Dongguan (CN)

(72) Inventors: Jianhui LI, Dongguan (CN); Xiaodong YANG, Dongguan (CN); Qian ZHENG, Dongguan (CN)

(73) Assignee: VIVO MOBILE COMMUNICATION CO., LTD., Dongguan (CN)

(21) Appl. No.: 18/642,737

(22) Filed: Apr. 22, 2024

Related U.S. Application Data
(63) Continuation of application No. PCT/CN2022/126442, filed on Oct. 20, 2022.

(30) Foreign Application Priority Data
Oct. 22, 2021 (CN) 202111236000.8

(51) Int. Cl. H04L 5/00; H04W 72/231

(52) U.S. Cl. CPC H04L 5/0035; H04L 5/0048; H04L 5/0053; H04L 5/0096; H04W 72/231

(57) ABSTRACT

An information configuration method includes: sending, by a network side device to a terminal, first information of a cell group serving the terminal, where the first information includes: M pieces of activation or deactivation indication information, where the activation or deactivation indication information is used to indicate whether to activate a corresponding secondary cell; and N pieces of indication information of a temporary reference signal configuration, where the indication information of a temporary reference signal configuration is used to indicate the temporary reference signal configuration that is used by the terminal to activate a secondary cell or a secondary cell group; and the secondary cell group includes one or more secondary cells, where M is equal to the number of secondary cells that are configured for the terminal, both N and M are integers greater than or equal to 1, and N is less than or equal to M.

### CROSS-REFERENCE TO RELATED APPLICATIONS

This application is a continuation of International Application No. PCT/CN2022/126442, filed Oct. 20, 2022, which claims priority to Chinese Patent Application No. 202111236000.8, filed Oct. 22, 2021. The entire contents of each of the above-referenced applications are expressly incorporated herein by reference.

### TECHNICAL FIELD

This application relates to the field of communication technologies, and in particular, to an information configuration method and apparatus, a network side device, and a terminal.

### BACKGROUND

For a cell group, when a primary cell schedules a resource, if resources available for self-scheduling are insufficient or tight, a secondary cell can be quickly activated for the terminal and instructed to cross-carrier schedule the resource of the primary cell.

When the network activates the secondary cell by using a temporary reference signal, the current Media Access Control Control Element (MAC CE) for activating the secondary cell only indicates whether the secondary cell is activated, but whether the secondary cell activates the use of the temporary reference signal and which temporary reference signal configuration is to be used need to be configured for the terminal through other signaling, and there may be some delays between this signaling and the MAC CE, which leads to the terminal being unable to activate the secondary cell quickly.

In the conventional technology, the primary cell can cross-carrier schedule the resource of the secondary cell. If the network supports the secondary cell in cross-carrier scheduling the resource of the primary cell, the conventional cross-carrier scheduling configuration information does not support the primary cell in being cross-carrier scheduled by other cells.

### SUMMARY

Embodiments of this application provide an information configuration method and apparatus, a network side device, and a terminal.

According to a first aspect, an information configuration method is provided, including:
sending, by a network side device to a terminal, first information of a cell group serving the terminal, where the first information includes:
M pieces of activation or deactivation indication information, where the activation or deactivation indication information is used to indicate whether to activate a corresponding secondary cell;
and
N pieces of indication information of a temporary reference signal configuration, where the indication information of a temporary reference signal configuration is used to indicate the temporary reference signal configuration that is used by the terminal to activate a secondary cell or a secondary cell group; and the secondary cell group includes one or more secondary cells, where
M is equal to the number of secondary cells that are configured for the terminal, both N and M are integers greater than or equal to 1, and N is less than or equal to M.

According to a second aspect, an information configuration method is provided, including:
receiving, by a terminal, first information of a cell group serving the terminal sent by a network side device, where the first information includes:
M pieces of activation or deactivation indication information, where the activation or deactivation indication information is used to indicate whether to activate a corresponding secondary cell;
and
N pieces of indication information of a temporary reference signal configuration, where the indication information of a temporary reference signal configuration is used to indicate the temporary reference signal configuration that is used by the terminal to activate a secondary cell or a secondary cell group; and the secondary cell group includes one or more secondary cells, where
M is equal to the number of secondary cells that are configured for the terminal, both N and M are integers greater than or equal to 1, and N is less than or equal to M.

According to a third aspect, an information configuration method is provided, including:
sending, by a network side device to a terminal, second information of a cell group serving the terminal, where the second information is used to indicate that a primary cell supports a resource in being self-scheduled and cross-carrier scheduled.

According to a fourth aspect, an information configuration method is provided, including:
receiving, by the terminal, second information of the cell group serving the terminal sent by a network side device, where the second information is used to indicate that a primary cell supports a resource in being self-scheduled and cross-carrier scheduled.

According to a fifth aspect, an information configuration apparatus is provided, including:
a first sending module, configured to send, to a terminal, first information of a cell group serving the terminal, where the first information includes:
M pieces of activation or deactivation indication information, where the activation or deactivation indication information is used to indicate whether to activate a corresponding secondary cell;
and
N pieces of indication information of a temporary reference signal configuration, where the indication information of a temporary reference signal configuration is used to indicate the temporary reference signal configuration that is used by the terminal to activate a secondary cell or a secondary cell group; and the secondary cell group includes one or more secondary cells, where
M is equal to the number of secondary cells that are configured for the terminal, both N and M are integers greater than or equal to 1, and N is less than or equal to M.

According to a sixth aspect, an information configuration apparatus is provided, including:
a first receiving module, configured to receive first information of a cell group serving the terminal sent by a network side device, where the first information includes:
M pieces of activation or deactivation indication information, where the activation or deactivation indication information is used to indicate whether to activate a corresponding secondary cell;
and
N pieces of indication information of a temporary reference signal configuration, where the indication information of a temporary reference signal configuration is used to indicate the temporary reference signal configuration that is used by the terminal to activate a secondary cell or a secondary cell group; and the secondary cell group includes one or more secondary cells, where
M is equal to the number of secondary cells that are configured for the terminal, both N and M are integers greater than or equal to 1, and N is less than or equal to M.

According to a seventh aspect, an information configuration apparatus is provided, including:
a second sending module, configured to send, to a terminal, second information of a cell group serving the terminal, where the second information is used to indicate that a primary cell supports a resource in being self-scheduled and cross-carrier scheduled.

According to an eighth aspect, an information configuration apparatus is provided, including:

a second receiving module, configured to receive second information of the cell group serving the terminal sent by a network side device, where the second information is used to indicate that a primary cell supports a resource in being self-scheduled and cross-carrier scheduled.

According to a ninth aspect, a network side device is provided. The network side device includes a processor, a memory, and a program or an instruction stored in the memory and executable on the processor, and the program or the instruction is executed by the processor to implement steps of the method according to the first aspect or the third aspect.

According to a tenth aspect, a terminal is provided. The terminal includes a processor, a memory, and a program or an instruction stored in the memory and executable on the processor, where the program or the instruction is executed by the processor to implement steps of the method according to the second aspect or the fourth aspect.

According to an eleventh aspect, a readable storage medium is provided. The readable storage medium stores a program or an instruction, and when the program or the instruction is executed by a processor, steps of the method according to the first aspect, the second aspect, the third aspect, or the fourth aspect are implemented.

According to a twelfth aspect, a chip is provided. The chip includes a processor and a communication interface, the communication interface is coupled to the processor, and the processor is configured to run a program or an instruction to implement the method according to the first aspect, the second aspect, the third aspect, or the fourth aspect.

According to a thirteenth aspect, a computer program/program product is provided. The computer program/program product is stored in a non-transient storage medium, and the program/program product is executed by at least one processor to implement steps of the method according to the first aspect, the second aspect, the third aspect, or the fourth aspect.

In the embodiments of this application, the network side device sends, to the terminal, the first information of the cell group serving the terminal, the first information includes M pieces of activation or deactivation indication information and N pieces of indication information of a temporary reference signal configuration, and the terminal can quickly activate the secondary cell based on the first information; and/or the network side device sends, to the terminal, second information of the cell group serving the terminal, and the terminal can determine, based on the second information, that the primary cell supports a resource in being self-scheduled and cross-carrier scheduled, so that the secondary cell can cross-carrier schedule the resource of the primary cell.

### BRIEF DESCRIPTION OF DRAWINGS

FIG. 1 is a block diagram of a wireless communication system to which the embodiments of this application can be applied;

FIG. 2 is a first flowchart of steps of an information configuration method according to an embodiment of this application;

FIG. 3 is a first example of a MAC CE according to an embodiment of this application;

FIG. 4 is a second example of a MAC CE according to an embodiment of this application;

FIG. 5 is a third example of a MAC CE according to an embodiment of this application;

FIG. 6 is a fourth example of a MAC CE according to an embodiment of this application;

FIG. 7 is a fifth example of a MAC CE according to an embodiment of this application;

FIG. 8 is a second flowchart of steps of an information configuration method according to an embodiment of this application;

FIG. 9 is a third flowchart of steps of an information configuration method according to an embodiment of this application;

FIG. 10 is a fourth flowchart of steps of an information configuration method according to an embodiment of this application;

FIG. 11 is a schematic diagram of a structure of an information configuration apparatus according to an embodiment of this application;

FIG. 12 is a schematic diagram of another structure of an information configuration apparatus according to an embodiment of this application;

FIG. 13 is a schematic diagram of still another structure of an information configuration apparatus according to an embodiment of this application;

FIG. 14 is a schematic diagram of yet another structure of an information configuration apparatus according to an embodiment of this application;

FIG. 15 is a schematic diagram of a structure of a communication device according to an embodiment of this application;

FIG. 16 is a schematic diagram of a structure of a terminal according to an embodiment of this application; and

FIG. 17 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

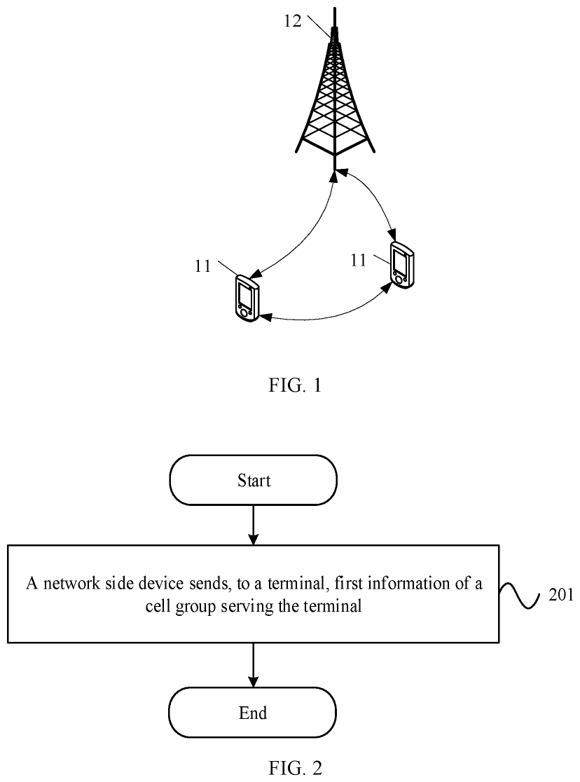

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), smart household (household devices with wireless communication functions, such as a refrigerator, a television, a washing machine, or furniture), and the wearable device include a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, a game console, and the like. The network side device 12 may be a base station or a core network. The base station may be referred to as a NodeB, an evolved Node B, an access point, a Base Transceiver Station (BTS), a radio base station, a radio transceiver, a Basic Service Set (BSS), an Extended Service Set (ESS), a home NodeB, a home evolved NodeB, a WLAN access point, a Wi-Fi node, a Transmitting Receiving Point (TRP), or another suitable term in the field provided that a same technical effect is achieved. The base station is not limited to a specific technical term. It should be noted that, in the embodiments of this application, only a base station in an NR system is used as an example, but a specific type of the base station is not limited.

The following describes in detail the information configuration method provided in the embodiments of this application through some embodiments and application scenarios thereof with reference to the accompanying drawings.

Referring to FIG. 2, FIG. 2 is a flowchart of an information configuration method according to an embodiment of this application, and the information configuration method includes the following steps.

Step 201. A network side device sends, to a terminal, first information of a cell group serving the terminal, where the first information includes:
M pieces of activation or deactivation indication information, where the activation or deactivation indication information is used to indicate whether to activate a corresponding secondary cell;
and
N pieces of indication information of a temporary reference signal configuration, where the indication information of a temporary reference signal configuration is used to indicate the temporary reference signal configuration that is used by the terminal to activate a secondary cell or a secondary cell group; and the secondary cell group includes one or more secondary cells, where
M is equal to the number of secondary cells that are configured for the terminal, both N and M are integers greater than or equal to 1, and N is less than or equal to M.

In this embodiment of this application, the network side device sends, to the terminal, the first information of the cell group serving the terminal, the first information includes M pieces of activation or deactivation indication information and N pieces of indication information of a temporary reference signal configuration, and the terminal can quickly activate the secondary cell based on the first information.

In at least one embodiment of this application, that the network side device sends the first information to the terminal in step 201 includes:
sending, by the network side device, a media access control control element (MAC CE) to the terminal, where the MAC CE carries the first information.

In this embodiment of this application, the MAC CE indicating the rapid activation of the secondary cell needs to simultaneously indicate whether to activate the secondary cell, and the temporary reference signal configuration used by the activated secondary cell or secondary cell group. Thus, the terminal can quickly activate the secondary cell, that is, accelerating the activation process of the secondary cell.

In some embodiments, the temporary reference signal configuration includes a plurality of pieces of sub-information, such as the number of reference signals (sets), an interval between reference signals, an offset between a reference signal and a reference time domain location, and the like, which is not specifically limited herein.

For example, M is equal to 31, that is, the MAC CE includes 31 pieces of activation or deactivation indication information, and each piece of activation or deactivation indication information indicates whether a corresponding secondary cell is activated. In some embodiments, one piece of activation or deactivation indication information occupies 1 bit. If the bit is 1, it indicates to activate the corresponding secondary cell, and if the bit is 0, it indicates to deactivate the corresponding secondary cell.

In some embodiments, N is less than or equal to M, for example, N can be equal to 31, or any integer less than 31.

In some embodiments, a value of N is the same as the number of activated secondary cells; for example, if the number of activated secondary cells is 5, then the value of N is 5; for another example, if the number of activated secondary cells is 7, then the value of N is 7; and that is, the number of bits carried by the MAC CE is variable, and the number of bits carried by the MAC CE is positively related to the number of activated secondary cells;
or
a value of N is the same as the number of activated secondary cell groups; for example, if the number of activated secondary cell groups is 6, then the value of N is 6; for another example, if the number of activated secondary cell groups is 8, then the value of N is 8; and that is, the number of bits carried by the MAC CE is variable, and the number of bits carried by the MAC CE is positively related to the number of activated secondary cell groups;
or
a value of N is the same as the number of secondary cells that are configured with a temporary reference signal configuration through second RRC signaling; for example, if the second RRC signaling is configured with the temporary reference signal configuration of 7 secondary cells, the value of N is equal to 7; and that is, the number of bits carried by the MAC CE is variable, and the number of bits carried by the MAC CE is positively related to the number of secondary cells that are configured with the temporary reference signal configuration in the RRC signaling;
or
a value of N is the same as the number of secondary cell groups that are configured with a temporary reference signal configuration through second RRC signaling; for example, if the second RRC signaling is configured with the temporary reference signal configuration of 4 secondary cell groups, the value of N is equal to 4; and that is, the number of bits carried by the MAC CE is variable, and the number of bits carried by the MAC CE is positively related to the number of secondary cell groups that are configured with the temporary reference signal configuration in the RRC signaling;
or
a value of N is configured or pre-agreed by the network side device; in this case, the value of N can be a fixed value; and correspondingly, in this case, the number of bits carried by the corresponding MAC CE is a fixed value.

In this embodiment of this application, the network side device dynamically adjusts the number of bits carried by the MAC CE based on the number of activated secondary cells or activated secondary cell groups or the number of secondary cells or secondary cell groups configured with the temporary reference signal configuration in the RRC signaling, so that the number of bits carried by the MAC CE can be reduced as much as possible in a case that the MAC CE can quickly activate the secondary cell.

In at least one embodiment of this application, the method further includes:
displaying and indicating, by the network side device through the MAC CE, the number of bits occupied by one piece of indication information of a temporary reference signal configuration;
or
displaying and indicating, by the network side device through first radio resource control (RRC) signaling, the number of bits occupied by one piece of indication information of a temporary reference signal configuration;
or
indirectly indicating, by the network side device through a maximum number of temporary reference signal configurations configured for a secondary cell in first RRC signaling, the number of bits occupied by one piece of indication information of a temporary reference signal configuration, for example, if the maximum number of temporary reference signal configurations configured for a secondary cell in the first RRC signaling is 3, the number of bits occupied by one piece of indication information of a temporary reference signal configuration is 2;
or
indirectly indicating, by the network side device through a maximum number of temporary reference signal configurations configured for a secondary cell group in first RRC signaling, the number of bits occupied by one piece of indication information of a temporary reference signal configuration, for example, if the maximum number of temporary reference signal configurations configured for a secondary cell group in the first RRC signaling is 6, the number of bits occupied by one piece of indication information of a temporary reference signal configuration is 3, where
the first RRC signaling is used to configure at least one temporary reference signal configuration for the secondary cell or the secondary cell group of the terminal.

Example 1, the MAC CE that is used to quickly activate the secondary cell.

When the network activates the secondary cell for the terminal, the temporary reference signal (Temporary RS) can be used to accelerate the activation of the secondary cell. The network can be used by each secondary cell (SCell) in the cell group serving the terminal to configure or preconfigure a plurality of Temporary RS configurations for the terminal.

When the MAC CE used to quickly activate the secondary cell is a variable-length MAC CE, it can also be referred to as that the number of bits carried by the MAC CE is variable, or the number of bits occupied by the MAC CE is variable. A MAC protocol data unit (PDU) carrying the MAC CE includes a MAC subheader and the MAC CE. The MAC subheader includes an L field, and the L field indicates a size of the corresponding MAC CE in byte.

When the network is used by each SCell in the cell group serving the terminal to configure or preconfigure a plurality of Temporary RS configurations for the terminal, that each SCell supports at most 3 configurations is used as an example, then the network can use 2 bits in the MAC CE to indicate which Temporary RS configuration in one SCell is activated (that is, the indication information of a temporary reference signal configuration occupies 2 bits). For example, 00 may indicate that the SCell does not activate the use of the Temporary RS, and Jan. 10, 2011 respectively represent a first configuration/second configuration/third configuration of a Temporary RS configuration sequence of the SCell.

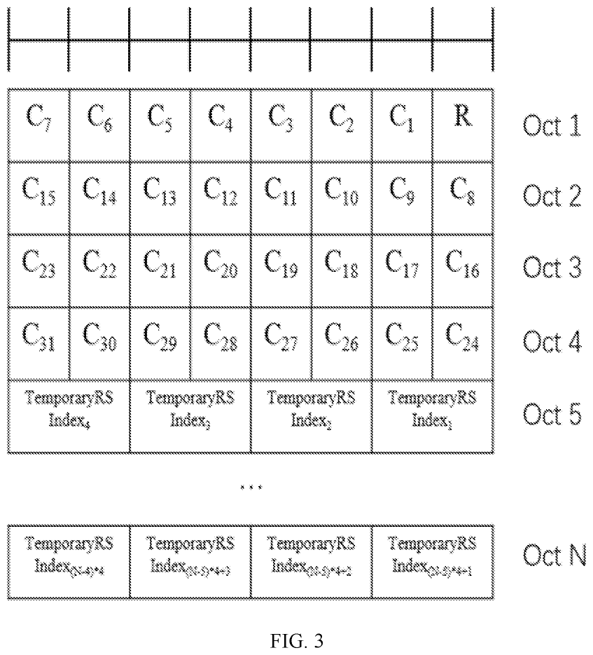

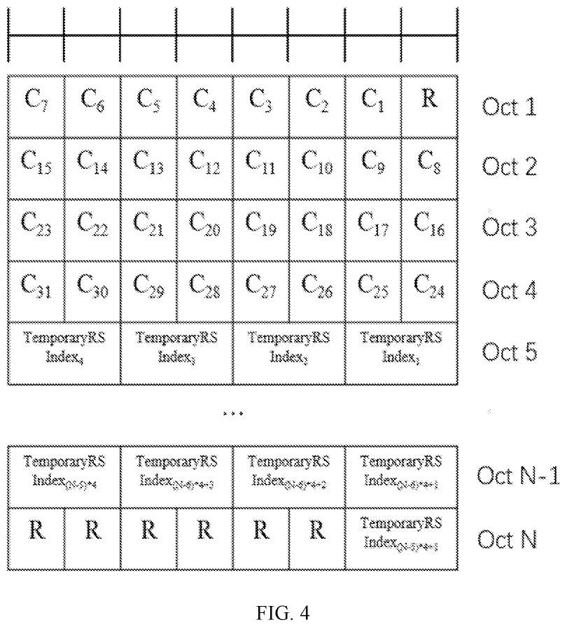

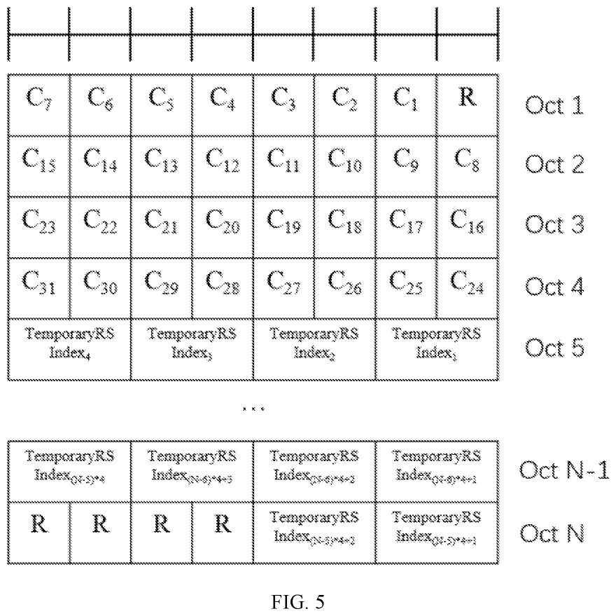

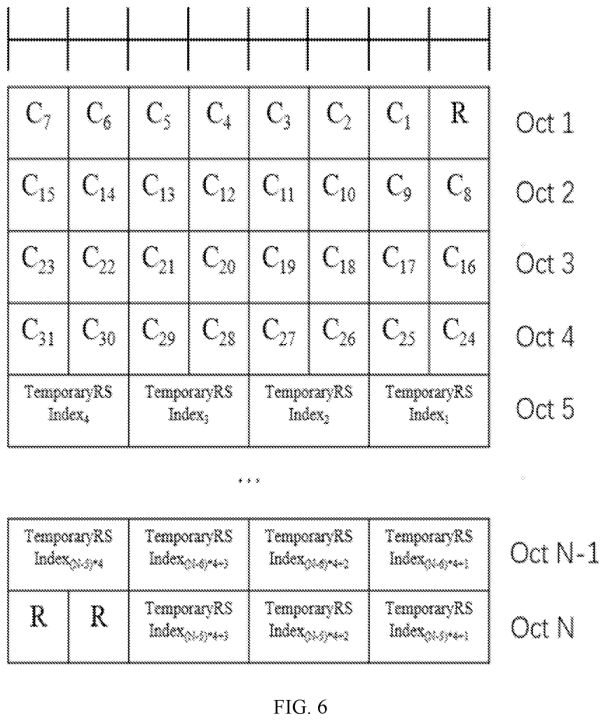

For example, if the indication of Temporary RS configuration of a secondary cell is represented by the above 2 bits, and the number N of pieces of the indication information of a temporary reference signal configuration is the same as the number of activated secondary cells, for supporting at most 31 secondary cells, the design of MAC CE includes:
referring to FIG. 3, FIG. 3 is the design of MAC CE when the number m of activated secondary cells meets m % 4=0;
referring to FIG. 4, FIG. 4 is the design of MAC CE when the number m of activated secondary cells meets m % 4=1;
referring to FIG. 5, FIG. 5 is the design of MAC CE when the number m of activated secondary cells meets m % 4=2; and
referring to FIG. 6, FIG. 6 is the design of MAC CE when the number m of activated secondary cells meets m % 4=3.

According to the “number m of activated secondary cells”, m refers to the number of activated SCells in 31 secondary cells (SCell), that is, in FIG. 3 to FIG. 6, C₁ to C₃₁ respectively represent activation or deactivation indication information of 31 secondary cells; and m is the number of Cᵢs that are set to 1 among the 31 bits, namely, C₁ to C₃₁.

Taking FIG. 3 as an example, it can be understood as m=(N−5)*4; taking FIG. 4 as an example, it can be understood as m=(N−5)*4+1; taking FIG. 5 as an example, it can be understood as m=(N−5)*4+2; and taking FIG. 6 as an example, it can be understood as m=(N−5)*4+3. N is the number of bytes included in the MAC CE.

In FIG. 3 to FIG. 6, a temporary reference signal index i (TemporaryRS Indexᵢ) indicates the indication information of a temporary reference signal configuration for activating the secondary cell. A correspondence between TemporaryRS Indexᵢ and the activated SCell can be defined by rules.

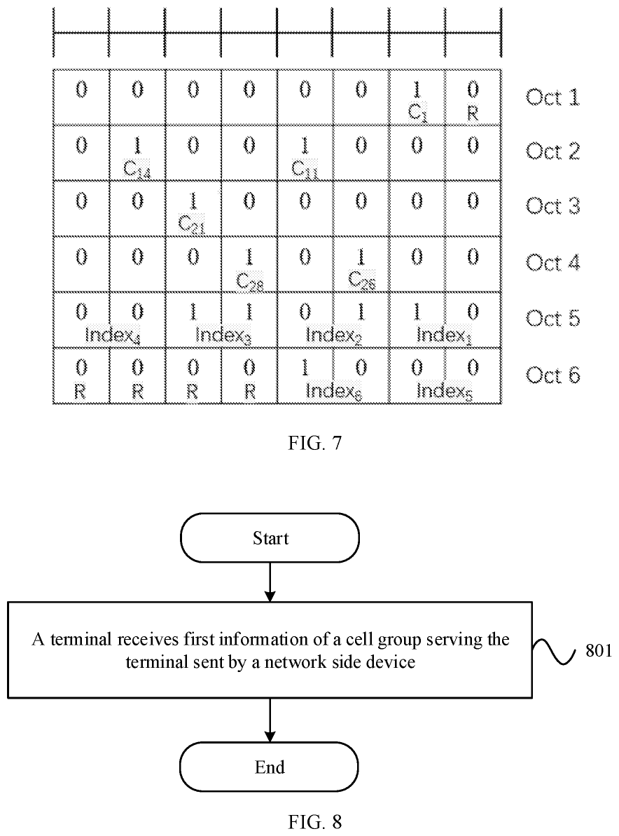

Taking the ascending correspondence as an example, and taking FIG. 7 as an example, the TemporaryRS Indexᵢ appearing from October 5 corresponds to, in an ascending order, the SCell indicated by Cᵢ bit that is set to 1. In FIG. 7, 6 SCells are activated, and then the MAC CE can be configured in the form of FIG. 5. C₁, C₁₁, C₁₄, C₂₁, C₂₆, and C₂₈ are set to 1. TemporaryRS Index₁ is set to 10, which is a second configuration of the Temporary RS configuration list corresponding to the secondary cell C₁. TemporaryRS Index₂ is set to 01, which is a first configuration of the Temporary RS configuration list corresponding to the secondary cell C₁₁; and TemporaryRS Index₄ is set to 00, which means that a secondary cell C₂₁ does not activate the use of Temporary RS, even if the secondary cell C₂₁ is configured with the Temporary RS configuration.

In at least one embodiment of this application, the method further includes:
sending, by the network side device to the terminal, second information of the cell group serving the terminal, where the second information is used to indicate that a primary cell supports a resource in being self-scheduled and cross-carrier scheduled.

In this embodiment of this application, the network side device sends, to the terminal, the second information of the cell group serving the terminal, and the terminal can determine, based on the second information, that the primary cell supports a resource in being self-scheduled and cross-carrier scheduled, so that the secondary cell can cross-carrier schedule the resource of the primary cell.

Correspondingly, the second information is cross-carrier scheduling configuration information (Cross Carrier Scheduling Config), and the sending, by the network side device to the terminal, second information of the cell group serving the terminal includes:
sending, by the network side device to the terminal, third RRC signaling, where the third RRC signaling carries the cross-carrier scheduling configuration information, and the cross-carrier scheduling configuration information includes a scheduling cell information field (schedulingCellInfo), where
in a case that the scheduling cell information field is set to be scheduled by other cells, the cross-carrier scheduling configuration information indicates that the primary cell supports a resource in being self-scheduled and cross-carrier scheduled.

For example, the SCell, which can cross-carrier schedule a primary (secondary) cell (P(S)Cell) resource, can be referred to as the sSCell (scheduling SCell). When schedulingCellInfo=other in “CrossCarrierSchedulingConfig” configured on the P(S)Cell, it implicitly indicates that the resource of the P(S)Cell can be self-scheduled and cross-carrier scheduled by the sSCell simultaneously.

In a case that the scheduling cell information field is set to be scheduled by other cells, the cross-carrier scheduling configuration information further includes:
a scheduling cell carrier indicator field (cif-InSchedulingCell), where a value configured for the carrier indicator field is associated with the primary cell, or a value configured for the carrier indicator field is associated with another secondary cell that can be cross-carrier scheduled by the secondary cell. For example, the value configured for the carrier indicator field can be any value in an optional value field.

In some embodiments, the cross-carrier scheduling configuration information further includes: scheduling cell identification information (schedulingCellId), and the scheduling cell identification information is used to indicate an identifier of a secondary cell that can cross-carrier schedule the primary cell resource. For example, schedulingCellId indicates the ID of the sSCell.

In this embodiment of this application, the Cell ID of the sSCell is indicated by the schedulingCellId, and the value configured for cif-InSchedulingCell can be determined by predefined rules, or can be any non-zero value, and the value can be associated with the primary cell (implicitly indicating that the resource of the primary cell can be cross-carrier scheduled by a corresponding secondary cell).

The method further includes:
sending, by the network side device, downlink control information to the terminal, where the downlink control information carries the carrier indicator field. For example, the network side device is a network side device corresponding to the secondary cell.

Correspondingly, the terminal determines, based on the value of the carrier indicator field carried by the downlink control information and the value configured for the scheduling cell carrier indicator field, whether to cross-carrier schedule, based on the downlink control information, the primary cell or the secondary cell associated with the value configured for the scheduling cell carrier indicator field.

For example, it is preconfigured or pre-agreed that the value 2 of the carrier indicator field is associated with the primary cell, and if a value of CIF in the downlink control information sent by the sSCell 2 which is a secondary cell of the scheduling cell is 2, it indicates that the scheduling information in the downlink control information is used for the sSCell 2 to cross-carrier schedule the resource of the corresponding primary cell. Further, if the value of CIF in the downlink control information sent by the sSCell 2 is 0, it indicates that the scheduling information in the downlink control information is used to schedule the resource of the sSCell 2.

In this embodiment of this application, the network side device sends, to the terminal, the first information of the cell group serving the terminal, the first information includes M pieces of activation or deactivation indication information and N pieces of indication information of a temporary reference signal configuration, and the terminal can quickly activate the secondary cell based on the first information; and the network side device sends, to the terminal, cross-carrier scheduling configuration information of the cell group serving the terminal, and the terminal can determine, based on the cross-carrier scheduling configuration information, that the primary cell supports a resource in being self-scheduled and cross-carrier scheduled, so that the secondary cell can cross-carrier schedule the resource of the primary cell.

Referring to FIG. 8, FIG. 8 is another flowchart of an information configuration method according to an embodiment of this application, and the information configuration method includes the following steps.

Step 801. A terminal receives first information of a cell group serving the terminal sent by a network side device, where the first information includes:
M pieces of activation or deactivation indication information, where the activation or deactivation indication information is used to indicate whether to activate a corresponding secondary cell;
and
N pieces of indication information of a temporary reference signal configuration, where the indication information of a temporary reference signal configuration is used to indicate the temporary reference signal configuration that is used by the terminal to activate a secondary cell or a secondary cell group; and the secondary cell group includes one or more secondary cells, where
M is equal to the number of secondary cells that are configured for the terminal, both N and M are integers greater than or equal to 1, and N is less than or equal to M.

In this embodiment of this application, the network side device sends, to the terminal, the first information of the cell group serving the terminal, the first information includes M pieces of activation or deactivation indication information and N pieces of indication information of a temporary reference signal configuration, and the terminal can quickly activate the secondary cell based on the first information.

In at least one embodiment of this application, that a terminal receives first information of a cell group serving the terminal sent by a network side device in step 801 includes:
receiving, by the terminal, a media access control control element (MAC CE), where the MAC CE carries the first information.

In this embodiment of this application, the MAC CE indicating the rapid activation of the secondary cell needs to simultaneously indicate whether to activate the secondary cell, and the temporary reference signal configuration used by the activated secondary cell or secondary cell group. Thus, the terminal can quickly activate the secondary cell, that is, accelerating the activation process of the secondary cell.

In some embodiments, the temporary reference signal configuration includes a plurality of pieces of sub-information, such as the number of reference signals (sets), an interval between reference signals, an offset between a reference signal and a reference time domain location, and the like, which is not specifically limited herein.

For example, M is equal to 31, that is, the MAC CE includes 31 pieces of activation or deactivation indication information, and each piece of activation or deactivation indication information indicates whether a corresponding secondary cell is activated. In some embodiments, one piece of activation or deactivation indication information occupies 1 bit. If the bit is 1, it indicates to activate the corresponding secondary cell, and if the bit is 0, it indicates to deactivate the corresponding secondary cell.

In some embodiments, N is less than or equal to M, for example, N can be equal to 31, or any integer less than 31.

In some embodiments, a value of N is the same as the number of activated secondary cells; for example, if the number of activated secondary cells is 5, then the value of N is 5; for another example, if the number of activated secondary cells is 7, then the value of N is 7; and that is, the number of bits carried by the MAC CE is variable, and the number of bits carried by the MAC CE is positively related to the number of activated secondary cells;
or
a value of N is the same as the number of activated secondary cell groups; for example, if the number of activated secondary cell groups is 6, then the value of N is 6; for another example, if the number of activated secondary cell groups is 8, then the value of N is 8; and that is, the number of bits carried by the MAC CE is variable, and the number of bits carried by the MAC CE is positively related to the number of activated secondary cell groups;
or
a value of N is the same as the number of secondary cells that are configured with a temporary reference signal configuration through second RRC signaling; for example, if the second RRC signaling is configured with the temporary reference signal configuration of 7 secondary cells, the value of N is equal to 7; and that is, the number of bits carried by the MAC CE is variable, and the number of bits carried by the MAC CE is positively related to the number of secondary cells that are configured with the temporary reference signal configuration in the RRC signaling;
or
a value of N is the same as the number of secondary cell groups that are configured with a temporary reference signal configuration through second RRC signaling; for example, if the second RRC signaling is configured with the temporary reference signal configuration of 4 secondary cell groups, the value of N is equal to 4; and that is, the number of bits carried by the MAC CE is variable, and the number of bits carried by the MAC CE is positively related to the number of secondary cell groups that are configured with the temporary reference signal configuration in the RRC signaling;
or
a value of N is configured or pre-agreed by the network side device; in this case, the value of N can be a fixed value; and correspondingly, in this case, the number of bits carried by the corresponding MAC CE is a fixed value.

In this embodiment of this application, the network side device dynamically adjusts the number of bits carried by the MAC CE based on the number of activated secondary cells or activated secondary cell groups or the number of secondary cells or secondary cell groups configured with the temporary reference signal configuration in the RRC signaling, so that the number of bits carried by the MAC CE can be reduced as much as possible in a case that the MAC CE can quickly activate the secondary cell.

In at least one embodiment of this application, the method further includes:
determining, by the terminal based on displaying and indicating of the MAC CE, the number of bits occupied by one piece of indication information of a temporary reference signal configuration;
or
determining, by the terminal based on displaying and indicating of first radio resource control (RRC) signaling, the number of bits occupied by one piece of indication information of a temporary reference signal configuration;
or
determining, by the terminal based on a maximum number of temporary reference signal configurations configured for a secondary cell in first RRC signaling, the number of bits occupied by one piece of indication information of a temporary reference signal configuration, for example, if the maximum number of temporary reference signal configurations configured for a secondary cell in the first RRC signaling is 3, the number of bits occupied by one piece of indication information of a temporary reference signal configuration is 2;
or
determining, by the terminal based on a maximum number of temporary reference signal configurations configured for a secondary cell group in first RRC signaling, the number of bits occupied by one piece of indication information of a temporary reference signal configuration, for example, if the maximum number of temporary reference signal configurations configured for a secondary cell group in the first RRC signaling is 6, the number of bits occupied by one piece of indication information of a temporary reference signal configuration is 3, where
the first RRC signaling is used to configure at least one temporary reference signal configuration for the secondary cell or the secondary cell group of the terminal.

In at least one embodiment of this application, the method further includes:
receiving, by the terminal, second information of the cell group serving the terminal sent by a network side device, where the second information is used to indicate that a primary cell supports a resource in being self-scheduled and cross-carrier scheduled.

In this embodiment of this application, the network side device sends, to the terminal, the second information of the cell group serving the terminal, and the terminal can determine, based on the second information, that the primary cell supports a resource in being self-scheduled and cross-carrier scheduled, so that the secondary cell can cross-carrier schedule the resource of the primary cell.

Correspondingly, the second information is cross-carrier scheduling configuration information (Cross Carrier Scheduling Config), and the receiving, by a terminal, second information of a cell group serving the terminal sent by a network side device includes:
receiving, by the terminal, third RRC signaling, where the third RRC signaling carries the cross-carrier scheduling configuration information, and the cross-carrier scheduling configuration information includes a scheduling cell information field (schedulingCellInfo), where
in a case that the scheduling cell information field is set to be scheduled by other cells, the cross-carrier scheduling configuration information indicates that the primary cell supports a resource in being self-scheduled and cross-carrier scheduled.

For example, the SCell, which can cross-carrier schedule a primary (secondary) cell (P(S)Cell) resource, can be referred to as the sSCell (scheduling SCell). When schedulingCellInfo=other in “CrossCarrierSchedulingConfig” configured on the P(S)Cell, it implicitly indicates that the resource of the P(S)Cell can be self-scheduled and cross-carrier scheduled by the sSCell simultaneously.

In a case that the scheduling cell information field is set to be scheduled by other cells, the cross-carrier scheduling configuration information further includes:
a scheduling cell carrier indicator field (cif-InSchedulingCell), where a value configured for the carrier indicator field is associated with the primary cell, or a value configured for the carrier indicator field is associated with another secondary cell that can be cross-carrier scheduled by the secondary cell. For example, the value configured for the carrier indicator field can be any value in an optional value field.

In some embodiments, the cross-carrier scheduling configuration information further includes: scheduling cell identification information (schedulingCellId), and the scheduling cell identification information is used to indicate an identifier of a secondary cell that can cross-carrier schedule the primary cell resource. For example, schedulingCellId indicates the ID of the sSCell.

In this embodiment of this application, the Cell ID of the sSCell is indicated by the schedulingCellId, and the value configured for cif-InSchedulingCell can be determined by predefined rules, or can be any non-zero value, and the value can be associated with the primary cell (implicitly indicating that the resource of the primary cell can be cross-carrier scheduled by a corresponding secondary cell).

In some embodiments, the method further includes:
receiving, by the terminal, downlink control information sent by the network side terminal, where the downlink control information carries the carrier indicator field; and
determining, by the terminal based on a value of the carrier indicator field carried by the downlink control information and a value configured for the scheduling cell carrier indicator field, whether to cross-carrier schedule, based on the downlink control information, a primary cell or a secondary cell associated with the value configured for the scheduling cell carrier indicator field.

For example, the network side device is a network side device corresponding to the secondary cell.

For example, it is preconfigured or pre-agreed that the value 2 of the carrier indicator field is associated with the primary cell, and if a value of CIF in the downlink control information sent by the sSCell 2 which is a secondary cell of the scheduling cell is 2, it indicates that the scheduling information in the downlink control information is used for the sSCell 2 to cross-carrier schedule the resource of the corresponding primary cell. Further, if the value of CIF in the downlink control information sent by the sSCell 2 is 0, it indicates that the scheduling information in the downlink control information is used to schedule the resource of the sSCell 2.

In this embodiment of this application, the network side device sends, to the terminal, the first information of the cell group serving the terminal, the first information includes M pieces of activation or deactivation indication information and N pieces of indication information of a temporary reference signal configuration, and the terminal can quickly activate the secondary cell based on the first information; and the network side device sends, to the terminal, cross-carrier scheduling configuration information of the cell group serving the terminal, and the terminal can determine, based on the cross-carrier scheduling configuration information, that the primary cell supports a resource in being self-scheduled and cross-carrier scheduled, so that the secondary cell can cross-carrier schedule the resource of the primary cell.

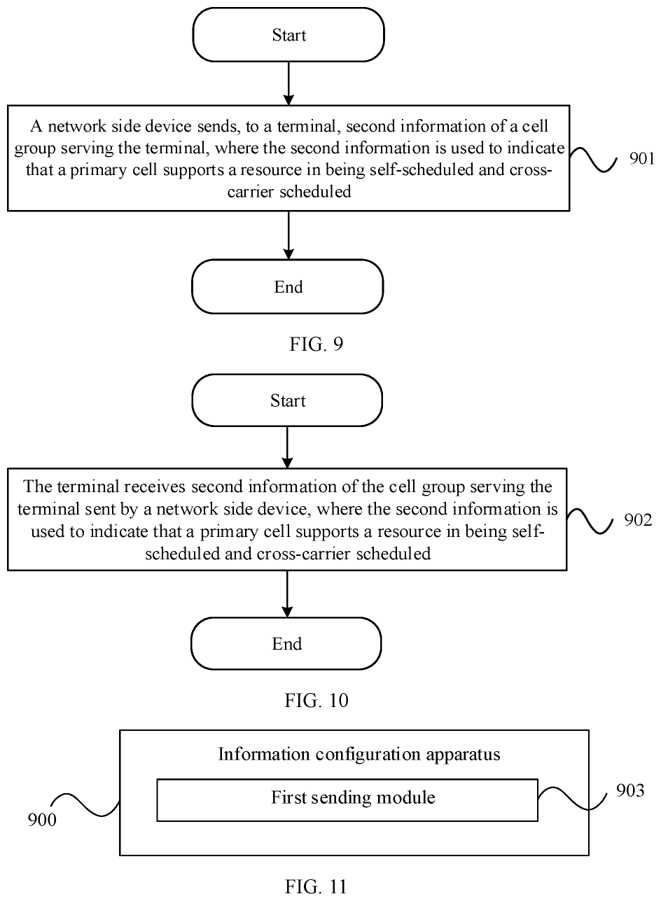

Referring to FIG. 9, FIG. 9 is still another flowchart of an information configuration method according to an embodiment of this application, and the information configuration method includes the following steps.

Step 901. A network side device sends, to a terminal, second information of a cell group serving the terminal, where the second information is used to indicate that a primary cell supports a resource in being self-scheduled and cross-carrier scheduled.

In this embodiment of this application, the network side device sends, to the terminal, the second information of the cell group serving the terminal, and the terminal can determine, based on the second information, that the primary cell supports a resource in being self-scheduled and cross-carrier scheduled, so that the secondary cell can cross-carrier schedule the resource of the primary cell.

Correspondingly, the second information is cross-carrier scheduling configuration information (Cross Carrier Scheduling Config), and step 901 includes:
sending, by the network side device to the terminal, third RRC signaling, where the third RRC signaling carries the cross-carrier scheduling configuration information, and the cross-carrier scheduling configuration information includes a scheduling cell information field (schedulingCellInfo), where
in a case that the scheduling cell information field is set to be scheduled by other cells, the cross-carrier scheduling configuration information indicates that the primary cell supports a resource in being self-scheduled and cross-carrier scheduled.

For example, the SCell, which can cross-carrier schedule a primary (secondary) cell (P(S)Cell) resource, can be referred to as the sSCell (scheduling SCell). When schedulingCellInfo=other in “CrossCarrierSchedulingConfig” configured on the P(S)Cell, it implicitly indicates that the resource of the P(S)Cell can be self-scheduled and cross-carrier scheduled by the sSCell simultaneously.

In a case that the scheduling cell information field is set to be scheduled by other cells, the cross-carrier scheduling configuration information further includes:
a scheduling cell carrier indicator field (cif-InSchedulingCell), where a value configured for the carrier indicator field is associated with the primary cell, or a value configured for the carrier indicator field is associated with another secondary cell that can be cross-carrier scheduled by the secondary cell. For example, the value configured for the carrier indicator field can be any value in an optional value field.

In some embodiments, the cross-carrier scheduling configuration information further includes: scheduling cell identification information (schedulingCellId), and the scheduling cell identification information is used to indicate an identifier of a secondary cell that can cross-carrier schedule the primary cell resource. For example, schedulingCellId indicates the ID of the sSCell.

In this embodiment of this application, the Cell ID of the sSCell is indicated by the schedulingCellId, and the value configured for cif-InSchedulingCell can be determined by predefined rules, or can be any non-zero value, and the value can be associated with the primary cell (implicitly indicating that the resource of the primary cell can be cross-carrier scheduled by a corresponding secondary cell).

The method further includes:
sending, by the network side device, downlink control information to the terminal, where the downlink control information carries the carrier indicator field. For example, the network side device is a network side device corresponding to the secondary cell.

Correspondingly, the terminal determines, based on the value of the carrier indicator field carried by the downlink control information and the value configured for the scheduling cell carrier indicator field, whether to cross-carrier schedule, based on the downlink control information, the primary cell or the secondary cell associated with the value configured for the scheduling cell carrier indicator field.

For example, it is preconfigured or pre-agreed that the value 2 of the carrier indicator field is associated with the primary cell, and if a value of CIF in the downlink control information sent by the sSCell 2 which is a secondary cell of the scheduling cell is 2, it indicates that the scheduling information in the downlink control information is used for the sSCell 2 to cross-carrier schedule the resource of the corresponding primary cell. Further, if the value of CIF in the downlink control information sent by the sSCell 2 is 0, it indicates that the scheduling information in the downlink control information is used to schedule the resource of the sSCell 2.

In this embodiment of this application, the network side device sends, to the terminal, the cross-carrier scheduling configuration information of the cell group serving the terminal, and the terminal can determine, based on the cross-carrier scheduling configuration information, that the primary cell supports a resource in being self-scheduled and cross-carrier scheduled, so that the secondary cell can cross-carrier schedule the resource of the primary cell.

Referring to FIG. 10, FIG. 10 is yet another flowchart of an information configuration method according to an embodiment of this application, and the information configuration method includes the following steps.

Step 902. The terminal receives second information of the cell group serving the terminal sent by a network side device, where the second information is used to indicate that a primary cell supports a resource in being self-scheduled and cross-carrier scheduled.

In this embodiment of this application, the network side device sends, to the terminal, the second information of the cell group serving the terminal, and the terminal can determine, based on the second information, that the primary cell supports a resource in being self-scheduled and cross-carrier scheduled, so that the secondary cell can cross-carrier schedule the resource of the primary cell.

Correspondingly, the second information is cross-carrier scheduling configuration information (Cross Carrier Scheduling Config), and step 902 includes:
receiving, by the terminal, third RRC signaling, where the third RRC signaling carries the cross-carrier scheduling configuration information, and the cross-carrier scheduling configuration information includes a scheduling cell information field (schedulingCellInfo), where
in a case that the scheduling cell information field is set to be scheduled by other cells, the cross-carrier scheduling configuration information indicates that the primary cell supports a resource in being self-scheduled and cross-carrier scheduled.

For example, the SCell, which can cross-carrier schedule a primary (secondary) cell (P(S)Cell) resource, can be referred to as the sSCell (scheduling SCell). When schedulingCellInfo=other in “CrossCarrierSchedulingConfig” configured on the P(S)Cell, it implicitly indicates that the resource of the P(S)Cell can be self-scheduled and cross-carrier scheduled by the sSCell simultaneously.

In a case that the scheduling cell information field is set to be scheduled by other cells, the cross-carrier scheduling configuration information further includes:
a scheduling cell carrier indicator field (cif-InSchedulingCell), where a value configured for the carrier indicator field is associated with the primary cell, or a value configured for the carrier indicator field is associated with another secondary cell that can be cross-carrier scheduled by the secondary cell. For example, the value configured for the carrier indicator field can be any value in an optional value field.

In some embodiments, the cross-carrier scheduling configuration information further includes: scheduling cell identification information (schedulingCellId), and the scheduling cell identification information is used to indicate an identifier of a secondary cell that can cross-carrier schedule the primary cell resource. For example, schedulingCellId indicates the ID of the sSCell.

In this embodiment of this application, the Cell ID of the sSCell is indicated by the schedulingCellId, and the value configured for cif-InSchedulingCell can be determined by predefined rules, or can be any non-zero value, and the value can be associated with the primary cell (implicitly indicating that the resource of the primary cell can be cross-carrier scheduled by a corresponding secondary cell).

In some embodiments, the method further includes:
receiving, by the terminal, downlink control information sent by the network side terminal, where the downlink control information carries the carrier indicator field; and
determining, by the terminal based on a value of the carrier indicator field carried by the downlink control information and a value configured for the scheduling cell carrier indicator field, whether to cross-carrier schedule, based on the downlink control information, a primary cell or a secondary cell associated with the value configured for the scheduling cell carrier indicator field.

For example, the network side device is a network side device corresponding to the secondary cell.

For example, it is preconfigured or pre-agreed that the value 2 of the carrier indicator field is associated with the primary cell, and if a value of CIF in the downlink control information sent by the sSCell 2 which is a secondary cell of the scheduling cell is 2, it indicates that the scheduling information in the downlink control information is used for the sSCell 2 to cross-carrier schedule the resource of the corresponding primary cell. Further, if the value of CIF in the downlink control information sent by the sSCell 2 is 0, it indicates that the scheduling information in the downlink control information is used to schedule the resource of the sSCell 2.

In this embodiment of this application, the network side device sends, to the terminal, the cross-carrier scheduling configuration information of the cell group serving the terminal, and the terminal can determine, based on the cross-carrier scheduling configuration information, that the primary cell supports a resource in being self-scheduled and cross-carrier scheduled, so that the secondary cell can cross-carrier schedule the resource of the primary cell.

It should be noted that an execution subject of the information configuration method provided in this embodiment of this application may be an information configuration apparatus, or a control module in the information configuration apparatus for executing the information configuration method. In this embodiment of this application, an example in which the information configuration method is implemented by the information configuration apparatus is used to describe the information configuration apparatus provided in this embodiment of this application.

Referring to FIG. 11, FIG. 11 is a schematic diagram of a structure of an information configuration apparatus according to an embodiment of this application, and the information configuration apparatus 900 includes:
a first sending module 903, configured to send, to a terminal, first information of a cell group serving the terminal, where the first information includes:
M pieces of activation or deactivation indication information, where the activation or deactivation indication information is used to indicate whether to activate a corresponding secondary cell;
and
N pieces of indication information of a temporary reference signal configuration, where the indication information of a temporary reference signal configuration is used to indicate the temporary reference signal configuration that is used by the terminal to activate a secondary cell or a secondary cell group; and the secondary cell group includes one or more secondary cells, where
M is equal to the number of secondary cells that are configured for the terminal, both N and M are integers greater than or equal to 1, and N is less than or equal to M.

In an embodiment, the first sending module includes:
a first sending submodule, configured to send a media access control control element (MAC CE) to the terminal, where the MAC CE carries the first information.

In an embodiment, the MAC CE includes:
M pieces of activation or deactivation indication information, where the activation or deactivation indication information is used to indicate whether to activate a corresponding secondary cell;
and
N pieces of indication information of a temporary reference signal configuration, where the indication information of a temporary reference signal configuration is used to indicate the temporary reference signal configuration that is used by the terminal to activate a secondary cell or a secondary cell group; and the secondary cell group includes one or more secondary cells, where
M is equal to the number of secondary cells that are configured for the terminal, both N and M are integers greater than or equal to 1, and N is less than or equal to M.

In an embodiment, the apparatus further includes:
an indicating module, configured to: display and indicate, through the MAC CE, the number of bits occupied by one piece of indication information of a temporary reference signal configuration; or
display and indicate, through first radio resource control (RRC) signaling, the number of bits occupied by one piece of indication information of a temporary reference signal configuration; or
indirectly indicate, through a maximum number of temporary reference signal configurations configured for a secondary cell in first RRC signaling, the number of bits occupied by one piece of indication information of a temporary reference signal configuration; or
indirectly indicate, through a maximum number of temporary reference signal configurations configured for a secondary cell group in first RRC signaling, the number of bits occupied by one piece of indication information of a temporary reference signal configuration, where
the first RRC signaling is used to configure at least one temporary reference signal configuration for the secondary cell or the secondary cell group of the terminal.

In an embodiment, a value of N is the same as the number of activated secondary cells;
or
a value of N is the same as the number of activated secondary cell groups;
or
a value of N is the same as the number of secondary cells that are configured with a temporary reference signal configuration through second RRC signaling;
or
a value of N is the same as the number of secondary cell groups that are configured with a temporary reference signal configuration through second RRC signaling;
or
a value of N is configured or pre-agreed by the network side device.

In an embodiment, the apparatus further includes:
a third sending module, configured to send, to a terminal, second information of a cell group serving the terminal, where the second information is used to indicate that a primary cell supports a resource in being self-scheduled and cross-carrier scheduled.

In an embodiment, the second information is cross-carrier scheduling configuration information, and the third sending module includes:
a third sending submodule, configured to send third RRC signaling to the terminal, where the third RRC signaling carries the cross-carrier scheduling configuration information, and the cross-carrier scheduling configuration information includes a scheduling cell information field, where
in a case that the scheduling cell information field is set to be scheduled by other cells, the cross-carrier scheduling configuration information indicates that the primary cell supports a resource in being self-scheduled and cross-carrier scheduled.

In an embodiment, in a case that the scheduling cell information field is set to be scheduled by other cells, the cross-carrier scheduling configuration information further includes:
a scheduling cell carrier indicator field, where a value configured for the carrier indicator field is associated with the primary cell, or a value configured for the carrier indicator field is associated with another secondary cell that can be cross-carrier scheduled by the secondary cell; and
the apparatus further includes:
a fourth sending module, configured to send downlink control information to the terminal, where the downlink control information carries the carrier indicator field.

In this embodiment of this application, the network side device sends, to the terminal, the first information of the cell group serving the terminal, the first information includes M pieces of activation or deactivation indication information and N pieces of indication information of a temporary reference signal configuration, and the terminal can quickly activate the secondary cell based on the first information; and the network side device sends, to the terminal, cross-carrier scheduling configuration information of the cell group serving the terminal, and the terminal can determine, based on the cross-carrier scheduling configuration information, that the primary cell supports a resource in being self-scheduled and cross-carrier scheduled, so that the secondary cell can cross-carrier schedule the resource of the primary cell.

It should be noted that the information configuration apparatus provided in the embodiments of this application is an apparatus that can perform the foregoing information configuration method. Therefore, all embodiments of the foregoing information configuration method are applicable to the apparatus, and a same or similar beneficial effect can be achieved.

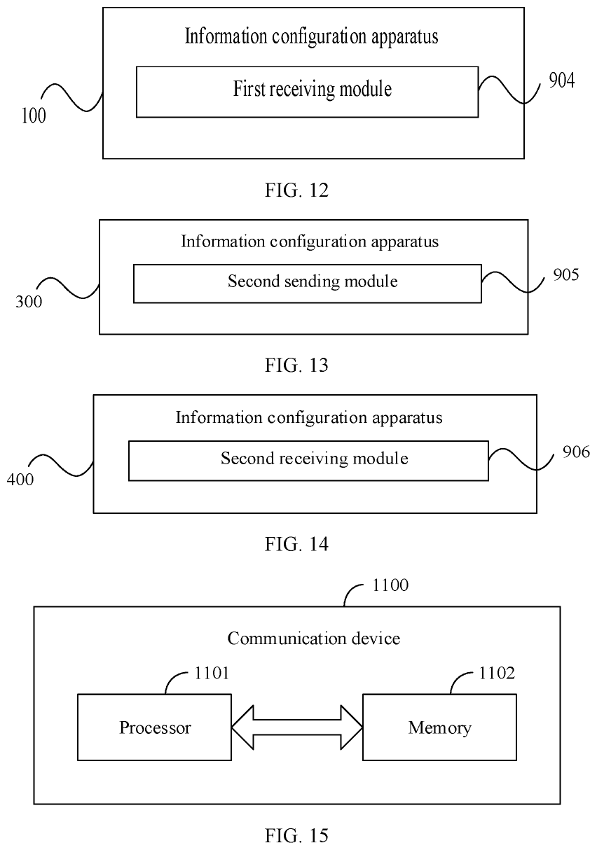

Referring to FIG. 12, FIG. 12 is a schematic diagram of another structure of an information configuration apparatus according to an embodiment of this application, and the information configuration apparatus 100 includes:
a first receiving module 904, configured to receive first information of a cell group serving the terminal sent by a network side device, where the first information includes:
M pieces of activation or deactivation indication information, where the activation or deactivation indication information is used to indicate whether to activate a corresponding secondary cell;
and
N pieces of indication information of a temporary reference signal configuration, where the indication information of a temporary reference signal configuration is used to indicate the temporary reference signal configuration that is used by the terminal to activate a secondary cell or a secondary cell group; and the secondary cell group includes one or more secondary cells, where
M is equal to the number of secondary cells that are configured for the terminal, both N and M are integers greater than or equal to 1, and N is less than or equal to M.

In an embodiment, the first receiving module includes:
a first receiving submodule, configured to receive a media access control control element (MAC CE), where the MAC CE carries the first information.

In an embodiment, the apparatus further includes:
a first determining module, configured to: determine, based on displaying and indicating of the MAC CE, the number of bits occupied by one piece of indication information of a temporary reference signal configuration;
or
determine, based on displaying and indicating of first radio resource control (RRC) signaling, the number of bits occupied by one piece of indication information of a temporary reference signal configuration;
or
determine, based on a maximum number of temporary reference signal configurations configured for a secondary cell in first RRC signaling, the number of bits occupied by one piece of indication information of a temporary reference signal configuration;
or
determine, based on a maximum number of temporary reference signal configurations configured for a secondary cell group in first RRC signaling, the number of bits occupied by one piece of indication information of a temporary reference signal configuration, where
the first RRC signaling is used to configure at least one temporary reference signal configuration for the secondary cell or the secondary cell group of the terminal.

In an embodiment, a value of N is the same as the number of activated secondary cells;
or
a value of N is the same as the number of activated secondary cell groups;
or
a value of N is the same as the number of secondary cells that are configured with a temporary reference signal configuration through second RRC signaling;
or
a value of N is the same as the number of secondary cell groups that are configured with a temporary reference signal configuration through second RRC signaling;
or
a value of N is configured or pre-agreed by the network side device.

In an embodiment, the apparatus further includes:
a third receiving module, configured to receive second information of the cell group serving the terminal sent by a network side device, where the second information is used to indicate that a primary cell supports a resource in being self-scheduled and cross-carrier scheduled.

In an embodiment, the second information is cross-carrier scheduling configuration information, and the third receiving module includes:
a third receiving submodule, configured to receive third RRC signaling, where the third RRC signaling carries the cross-carrier scheduling configuration information, and the cross-carrier scheduling configuration information includes a scheduling cell information field, where
in a case that the scheduling cell information field is set to be scheduled by other cells, the cross-carrier scheduling configuration information indicates that the primary cell supports a resource in being self-scheduled and cross-carrier scheduled.

In an embodiment, in a case that the scheduling cell information field is set to be scheduled by other cells, the cross-carrier scheduling configuration information further includes:
a scheduling cell carrier indicator field, where a value configured for the carrier indicator field is associated with the primary cell, or a value configured for the carrier indicator field is associated with another secondary cell that can be cross-carrier scheduled by the secondary cell; and
the apparatus further includes:
a fourth receiving module, configured to receive downlink control information sent by the network side terminal, where the downlink control information carries the carrier indicator field; and
a second determining module, configured to determine, based on a value of the carrier indicator field carried by the downlink control information and a value configured for the scheduling cell carrier indicator field, whether to cross-carrier schedule, based on the downlink control information, a primary cell or a secondary cell associated with the value configured for the scheduling cell carrier indicator field.

In this embodiment of this application, the network side device sends, to the terminal, the first information of the cell group serving the terminal, the first information includes M pieces of activation or deactivation indication information and N pieces of indication information of a temporary reference signal configuration, and the terminal can quickly activate the secondary cell based on the first information; and the network side device sends, to the terminal, cross-carrier scheduling configuration information of the cell group serving the terminal, and the terminal can determine, based on the cross-carrier scheduling configuration information, that the primary cell supports a resource in being self-scheduled and cross-carrier scheduled, so that the secondary cell can cross-carrier schedule the resource of the primary cell.

It should be noted that the information configuration apparatus provided in the embodiments of this application is an apparatus that can perform the foregoing information configuration method. Therefore, all embodiments of the foregoing information configuration method are applicable to the apparatus, and a same or similar beneficial effect can be achieved.

Referring to FIG. 13, FIG. 13 is a schematic diagram of another structure of an information configuration apparatus according to an embodiment of this application, and the information configuration apparatus 300 includes:
a second sending module 905, configured to send, to a terminal, second information of a cell group serving the terminal, where the second information is used to indicate that a primary cell supports a resource in being self-scheduled and cross-carrier scheduled.

In an embodiment, the second information is cross-carrier scheduling configuration information, and the second sending module includes:
a second sending submodule, configured to send third RRC signaling to the terminal, where the third RRC signaling carries the cross-carrier scheduling configuration information, and the cross-carrier scheduling configuration information includes a scheduling cell information field, where
in a case that the scheduling cell information field is set to be scheduled by other cells, the cross-carrier scheduling configuration information indicates that the primary cell supports a resource in being self-scheduled and cross-carrier scheduled.

In an embodiment, in a case that the scheduling cell information field is set to be scheduled by other cells, the cross-carrier scheduling configuration information further includes:
a scheduling cell carrier indicator field, where a value configured for the carrier indicator field is associated with the primary cell, or a value configured for the carrier indicator field is associated with another secondary cell that can be cross-carrier scheduled by the secondary cell; and
the apparatus further includes:
a control information sending module, configured to send downlink control information to the terminal, where the downlink control information carries the carrier indicator field.

In this embodiment of this application, the network side device sends, to the terminal, the cross-carrier scheduling configuration information of the cell group serving the terminal, and the terminal can determine, based on the cross-carrier scheduling configuration information, that the primary cell supports a resource in being self-scheduled and cross-carrier scheduled, so that the secondary cell can cross-carrier schedule the resource of the primary cell.

It should be noted that the information configuration apparatus provided in the embodiments of this application is an apparatus that can perform the foregoing information configuration method. Therefore, all embodiments of the foregoing information configuration method are applicable to the apparatus, and a same or similar beneficial effect can be achieved.

Referring to FIG. 14, FIG. 14 is a schematic diagram of another structure of an information configuration apparatus according to an embodiment of this application, and the information configuration apparatus 400 includes:
a second receiving module 906, configured to receive second information of the cell group serving the terminal sent by a network side device, where the second information is used to indicate that a primary cell supports a resource in being self-scheduled and cross-carrier scheduled.

In an embodiment, the second information is cross-carrier scheduling configuration information, and the second receiving module includes:
a second receiving submodule, configured to receive third RRC signaling, where the third RRC signaling carries the cross-carrier scheduling configuration information, and the cross-carrier scheduling configuration information includes a scheduling cell information field, where
in a case that the scheduling cell information field is set to be scheduled by other cells, the cross-carrier scheduling configuration information indicates that the primary cell supports a resource in being self-scheduled and cross-carrier scheduled.

In an embodiment, in a case that the scheduling cell information field is set to be scheduled by other cells, the cross-carrier scheduling configuration information further includes:
a scheduling cell carrier indicator field, where a value configured for the carrier indicator field is associated with the primary cell, or a value configured for the carrier indicator field is associated with another secondary cell that can be cross-carrier scheduled by the secondary cell; and
the apparatus further includes:
a control information receiving module, configured to receive downlink control information sent by the network side terminal, where the downlink control information carries the carrier indicator field; and
a second determining module, configured to determine, based on a value of the carrier indicator field carried by the downlink control information and a value configured for the scheduling cell carrier indicator field, whether to cross-carrier schedule, based on the downlink control information, a primary cell or a secondary cell associated with the value configured for the scheduling cell carrier indicator field.

In this embodiment of this application, the network side device sends, to the terminal, the cross-carrier scheduling configuration information of the cell group serving the terminal, and the terminal can determine, based on the cross-carrier scheduling configuration information, that the primary cell supports a resource in being self-scheduled and cross-carrier scheduled, so that the secondary cell can cross-carrier schedule the resource of the primary cell.

It should be noted that the information configuration apparatus provided in the embodiments of this application is an apparatus that can perform the foregoing information configuration method. Therefore, all embodiments of the foregoing information configuration method are applicable to the apparatus, and a same or similar beneficial effect can be achieved.

The information configuration apparatus in this embodiment of this application may be an apparatus or an apparatus or electronic device with an operating system, or may be a component, an integrated circuit, or a chip in a terminal. The apparatus or electronic device may be a mobile terminal, or a non-mobile terminal. For example, the mobile terminal may include but is not limited to the foregoing listed types of the terminal 11. The non-mobile terminal may be a server, a Network Attached Storage (NAS), a personal computer (PC), a television (TV), a teller machine, or a self-service machine. This is not specifically limited in this embodiment of this application.

The information configuration apparatus provided in this embodiment of this application can implement the processes implemented in the method embodiments in FIG. 1 to FIG. 10, and achieve a same technical effect. To avoid repetition, details are not described herein again.

As shown in FIG. 15, an embodiment of this application further provides a communication device 1100, including a processor 1101, a memory 1102, and a program or an instruction stored in the memory 1102 and executable on the processor 1101. For example, in a case that the communication device 1100 is a terminal, when the program or the instruction is executed by the processor 1101, the processes of the information configuration method embodiment in FIG. 8 or FIG. 10 are implemented, and a same technical effect can be achieved. In a case that the communication device 1100 is a network side device, when the program or the instruction is executed by the processor 1101, the processes of the information configuration method embodiment in FIG. 2 or FIG. 9 are implemented, and a same technical effect can be achieved. To avoid repetition, details are not described herein again.

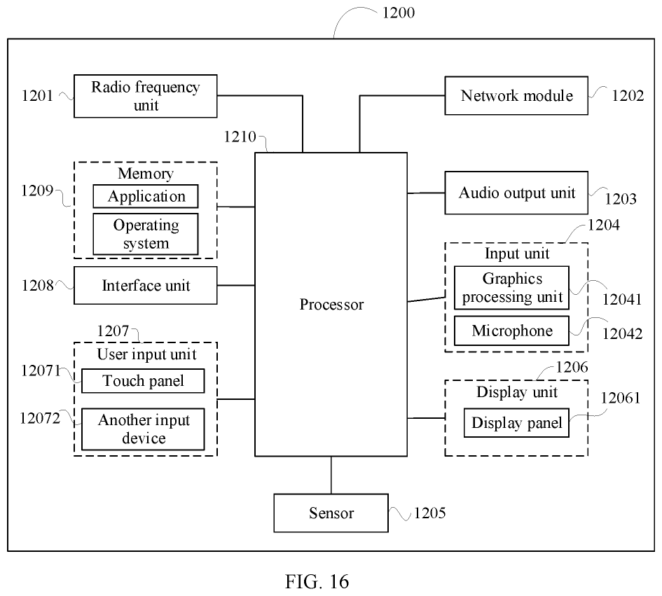

An embodiment of this application further provides a terminal, including a processor and a communication interface, and the communication interface is configured to receive first information of a cell group serving the terminal sent by a network side device, where the first information includes: M pieces of activation or deactivation indication information, where the activation or deactivation indication information is used to indicate whether to activate a corresponding secondary cell; and N pieces of indication information of a temporary reference signal configuration, where the indication information of a temporary reference signal configuration is used to indicate the temporary reference signal configuration that is used by the terminal to activate a secondary cell or a secondary cell group; and the secondary cell group includes one or more secondary cells, where M is equal to the number of secondary cells that are configured for the terminal, both N and M are integers greater than or equal to 1, and N is less than or equal to M. This terminal embodiment corresponds to the foregoing method embodiment on the terminal side. Each implementation process and implementation of the foregoing method embodiment may be applicable to this terminal embodiment, and a same technical effect can be achieved. FIG. 16 is a schematic diagram of a hardware structure of a terminal according to an embodiment of this application.

A terminal 1200 includes but is not limited to at least a part of components such as a radio frequency unit 12012, a network module 1202, an audio output unit 1203, an input unit 1204, a sensor 1205, a display unit 1206, a user input unit 1207, an interface unit 1208, a memory 1209, and a processor 1210.

A person skilled in the art can understand that the terminal 1200 may further include a power supply (such as a battery) that supplies power to each component. The power supply may be logically connected to the processor 1210 by using a power supply management system, to implement functions such as charging and discharging management, and power consumption management by using the power supply management system. The terminal structure shown in FIG. 16 constitutes no limitation on the terminal, and the terminal may include more or fewer components than those shown in the figure, or combine some components, or have different component arrangements. Details are not described herein.

It should be understood that in this embodiment of this application, the input unit 1204 may include a Graphics Processing Unit (GPU) 12041 and a microphone 12042. The graphics processing unit 12041 processes image data of a static picture or a video obtained by an image capture apparatus (for example, a camera) in a video capture mode or an image capture mode. The display unit 1206 may include a display panel 12061, and the display panel 12061 may be configured in a form of a liquid crystal display, an organic light-emitting diode, or the like. The user input unit 1207 includes a touch panel 12071 and another input device 12072. The touch panel 12071 is also referred to as a touchscreen. The touch panel 12071 may include two parts: a touch detection apparatus and a touch controller. The another input device 12072 may include but is not limited to a physical keyboard, a functional button (such as a volume control button or a power on/off button), a trackball, a mouse, and a joystick. Details are not described herein.

In this embodiment of this application, the radio frequency unit 1201 receives downlink data from a network side device and then sends the downlink data to the processor 1210 for processing; and sends uplink data to the network side device. Usually, the radio frequency unit 1201 includes but is not limited to an antenna, at least one amplifier, a transceiver, a coupler, a low noise amplifier, a duplexer, and the like.

The memory 1209 may be configured to store a software program or an instruction and various data. The memory 1209 may mainly include a program or instruction storage area and a data storage area. The program or instruction storage area may store an operating system, an application or an instruction required by at least one function (for example, a sound playing function or an image playing function), and the like. In addition, the memory 1209 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory, for example, at least one disk storage device, a flash memory device, or another non-volatile solid-state storage device.

The processor 1210 may include one or more processing units. In some embodiments, an application processor and a modem processor may be integrated into the processor 1210. The application processor mainly processes an operating system, a user interface, an application, an instruction, or the like. The modem processor mainly processes wireless communication, for example, a baseband processor. It may be understood that, the modem processor may not be integrated into the processor 1210.

The radio frequency unit 1201 is configured to receive first information of a cell group serving the terminal sent by a network side device, where the first information includes:
M pieces of activation or deactivation indication information, where the activation or deactivation indication information is used to indicate whether to activate a corresponding secondary cell;
and
N pieces of indication information of a temporary reference signal configuration, where the indication information of a temporary reference signal configuration is used to indicate the temporary reference signal configuration that is used by the terminal to activate a secondary cell or a secondary cell group; and the secondary cell group includes one or more secondary cells, where
M is equal to the number of secondary cells that are configured for the terminal, both N and M are integers greater than or equal to 1, and N is less than or equal to M.

In some embodiments, the radio frequency unit 1201 is configured to receive second information of the cell group serving the terminal sent by a network side device, where the second information is used to indicate that a primary cell supports a resource in being self-scheduled and cross-carrier scheduled.

In this embodiment of this application, the network side device sends, to the terminal, the first information of the cell group serving the terminal, the first information includes M pieces of activation or deactivation indication information and N pieces of indication information of a temporary reference signal configuration, and the terminal can quickly activate the secondary cell based on the first information; and the network side device sends, to the terminal, second information of the cell group serving the terminal, and the terminal can determine, based on the second information, that the primary cell supports a resource in being self-scheduled and cross-carrier scheduled, so that the secondary cell can cross-carrier schedule the resource of the primary cell.

It should be noted that the terminal provided in the embodiments of this application is a terminal that can perform the foregoing information configuration method. Therefore, all embodiments of the foregoing information configuration method are applicable to the terminal, and a same or similar beneficial effect can be achieved.

An embodiment of this application further provides a network side terminal, including a processor and a communication interface, and the communication interface is configured to send, to the terminal, first information of a cell group serving the terminal, where the first information includes: M pieces of activation or deactivation indication information, where the activation or deactivation indication information is used to indicate whether to activate a corresponding secondary cell; and N pieces of indication information of a temporary reference signal configuration, where the indication information of a temporary reference signal configuration is used to indicate the temporary reference signal configuration that is used by the terminal to activate a secondary cell or a secondary cell group; and the secondary cell group includes one or more secondary cells, where M is equal to the number of secondary cells that are configured for the terminal, both N and M are integers greater than or equal to 1, and N is less than or equal to M. In some embodiments, the communication interface is configured to send, to a terminal, second information of a cell group serving the terminal, where the second information is used to indicate that a primary cell supports a resource in being self-scheduled and cross-carrier scheduled. This network side device embodiment corresponds to the foregoing method embodiment on the network side device. Each implementation process and implementation of the foregoing method embodiment may be applicable to this network side device embodiment, and a same technical effect can be achieved.

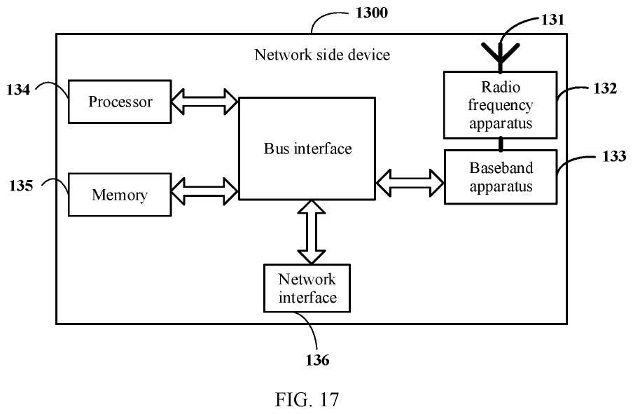

An embodiment of this application further provides a network side device. As shown in FIG. 17, a network device 1300 includes an antenna 131, a radio frequency apparatus 132, and a baseband apparatus 133. The antenna 131 is connected to the radio frequency apparatus 132. In an uplink direction, the radio frequency apparatus 132 receives information by using the antenna 131, and sends the received information to the baseband apparatus 133 for processing. In a downlink direction, the baseband apparatus 133 processes information that needs to be sent, and sends processed information to the radio frequency apparatus 132. The radio frequency apparatus 132 processes the received information, and sends processed information by using the antenna 131.

The frequency band processing apparatus may be located in the baseband apparatus 133. The method performed by the network side device in the foregoing embodiment may be implemented in the baseband apparatus 133. The baseband apparatus 133 includes a processor 134 and a memory 135.

The baseband apparatus 133 may include, for example, at least one baseband board, where a plurality of chips are disposed on the baseband board. As shown in FIG. 17, one chip is, for example, the processor 134, which is connected to the memory 135, so as to invoke a program in the memory 135 to perform operations of the network device shown in the foregoing method embodiment.

The baseband apparatus 133 may further include a network interface 136, configured to exchange information with the radio frequency apparatus 132. For example, the interface is a common public radio interface (CPRI).

The network side device in this embodiment of the present application further includes an instruction or a program that is stored in the memory 135 and that can be run on the processor 134. The processor 134 invokes the instruction or the program in the memory 135 to perform the method performed by the modules shown in FIG. 11 or FIG. 13, and a same technical effect is achieved. To avoid repetition, details are not described herein again.

An embodiment of this application further provides a readable storage medium. The readable storage medium stores a program or an instruction. When the program or the instruction is executed by a processor, the processes of the information configuration method embodiment in FIG. 2, FIG. 8, FIG. 9, or FIG. 10 are implemented, and a same technical effect is achieved. To avoid repetition, details are not described herein again.

The processor is a processor in the terminal in the foregoing embodiment. The readable storage medium includes a computer-readable storage medium such as a Read-Only Memory (ROM), a Random Access Memory (RAM), a magnetic disk, an optical disc, or the like.

An embodiment of this application further provides a chip. The chip includes a processor and a communication interface. The communication interface is coupled to the processor, the processor is configured to run a program or an instruction, to implement the processes of the information configuration method embodiment shown in FIG. 2, FIG. 8, FIG. 9, or FIG. 10, and a same technical effect can be achieved. To avoid repetition, details are not described herein again.

It should be understood that the chip mentioned in this embodiment of this application may also be referred to as a system-level chip, a system chip, a chip system, or a system on chip.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be a mobile phone, a computer, a server, an air-conditioner, a network device, or the like) to perform the method described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

1. A method for information configuration, comprising:
sending, by a network side device to a terminal, first information of a cell group serving the terminal, wherein the first information comprises:
M pieces of activation or deactivation indication information, wherein the activation or deactivation indication information is used to indicate whether to activate a corresponding secondary cell; and
N pieces of indication information of a temporary reference signal configuration, wherein the indication information of a temporary reference signal configuration is used to indicate the temporary reference signal configuration that is used by the terminal to activate a secondary cell or a secondary cell group; and the secondary cell group comprises one or more secondary cells,
wherein M is equal to the number of secondary cells that are configured for the terminal, both N and M are integers greater than or equal to 1, and N is less than or equal to M.

2. The method according to claim 1, wherein sending, by the network side device to the terminal, the first information comprises:
sending, by the network side device, a media access control control element (MAC CE) to the terminal, wherein the MAC CE carries the first information.

3. The method according to claim 1, further comprising:
displaying and indicating, by the network side device through a MAC CE, the number of bits occupied by one piece of indication information of a temporary reference signal configuration;
displaying and indicating, by the network side device through first radio resource control (RRC) signaling, the number of bits occupied by one piece of indication information of a temporary reference signal configuration;
indirectly indicating, by the network side device through a maximum number of temporary reference signal configurations configured for a secondary cell in first RRC signaling, the number of bits occupied by one piece of indication information of a temporary reference signal configuration; or
indirectly indicating, by the network side device through a maximum number of temporary reference signal configurations configured for a secondary cell group in first RRC signaling, the number of bits occupied by one piece of indication information of a temporary reference signal configuration,
wherein the first RRC signaling is used to configure at least one temporary reference signal configuration for the secondary cell or the secondary cell group of the terminal.

4. The method according to claim 1, wherein:
a value of N is the same as the number of activated secondary cells;
a value of N is the same as the number of activated secondary cell groups;
a value of N is the same as the number of secondary cells that are configured with a temporary reference signal configuration through second RRC signaling;
a value of N is the same as the number of secondary cell groups that are configured with a temporary reference signal configuration through second RRC signaling; or
a value of N is configured or pre-agreed by the network side device.

5. The method according to claim 1, further comprising:
sending, by the network side device to the terminal, second information of the cell group serving the terminal, wherein the second information is used to indicate that a primary cell supports a resource in being self-scheduled and cross-carrier scheduled.

6. The method according to claim 5, wherein the second information is cross-carrier scheduling configuration information; and
the sending, by the network side device to the terminal, the second information of the cell group serving the terminal comprises:
sending, by the network side device to the terminal, third RRC signaling, wherein the third RRC signaling carries the cross-carrier scheduling configuration information, and the cross-carrier scheduling configuration information comprises a scheduling cell information field,
wherein when the scheduling cell information field is set to be scheduled by other cells, the cross-carrier scheduling configuration information indicates that the primary cell supports a resource in being self-scheduled and cross-carrier scheduled.

7. The method according to claim 6, wherein when the scheduling cell information field is set to be scheduled by other cells, the cross-carrier scheduling configuration information further comprises:
a scheduling cell carrier indicator field, wherein a value configured for the carrier indicator field is associated with the primary cell, or a value configured for the carrier indicator field is associated with another secondary cell that can be cross-carrier scheduled by the secondary cell; and
the method further comprises:
sending, by the network side device, downlink control information to the terminal, wherein the downlink control information carries the carrier indicator field.

8. A method for information configuration, comprising:
receiving, by a terminal, first information of a cell group serving the terminal sent by a network side device, wherein the first information comprises:
M pieces of activation or deactivation indication information, wherein the activation or deactivation indication information is used to indicate whether to activate a corresponding secondary cell; and
N pieces of indication information of a temporary reference signal configuration, wherein the indication information of a temporary reference signal configuration is used to indicate the temporary reference signal configuration that is used by the terminal to activate a secondary cell or a secondary cell group; and the secondary cell group comprises one or more secondary cells,
Wherein M is equal to the number of secondary cells that are configured for the terminal, both N and M are integers greater than or equal to 1, and N is less than or equal to M.

9. The method according to claim 8, wherein receiving, by the terminal, the first information of the cell group serving the terminal sent by the network side device comprises:
receiving, by the terminal, a media access control control element (MAC CE), wherein the MAC CE carries the first information.

10. The method according to claim 8, further comprising:
determining, by the terminal based on displaying and indicating of the MAC CE, the number of bits occupied by one piece of indication information of a temporary reference signal configuration;
determining, by the terminal based on displaying and indicating of first radio resource control (RRC) signaling, the number of bits occupied by one piece of indication information of a temporary reference signal configuration;
determining, by the terminal based on a maximum number of temporary reference signal configurations configured for a secondary cell in first RRC signaling, the number of bits occupied by one piece of indication information of a temporary reference signal configuration; or
determining, by the terminal based on a maximum number of temporary reference signal configurations configured for a secondary cell group in first RRC signaling, the number of bits occupied by one piece of indication information of a temporary reference signal configuration,
wherein the first RRC signaling is used to configure at least one temporary reference signal configuration for the secondary cell or the secondary cell group of the terminal.

11. The method according to claim 8, wherein:
a value of N is the same as the number of activated secondary cells;
a value of N is the same as the number of activated secondary cell groups;
a value of N is the same as the number of secondary cells that are configured with a temporary reference signal configuration through second RRC signaling;
a value of N is the same as the number of secondary cell groups that are configured with a temporary reference signal configuration through second RRC signaling; or
a value of N is configured or pre-agreed by the network side device.

12. The method according to claim 8, further comprising:
receiving, by the terminal, second information of the cell group serving the terminal sent by a network side device, wherein the second information is used to indicate that a primary cell supports a resource in being self-scheduled and cross-carrier scheduled.

13. The method according to claim 12, wherein the second information is cross-carrier scheduling configuration information; and the receiving, by the terminal, the second information of the cell group serving the terminal sent by the network side device comprises:
receiving, by the terminal, third RRC signaling, wherein the third RRC signaling carries the cross-carrier scheduling configuration information, and the cross-carrier scheduling configuration information comprises a scheduling cell information field,
wherein when the scheduling cell information field is set to be scheduled by other cells, the cross-carrier scheduling configuration information indicates that the primary cell supports a resource in being self-scheduled and cross-carrier scheduled.

14. The method according to claim 13, wherein when the scheduling cell information field is set to be scheduled by other cells, the cross-carrier scheduling configuration information further comprises:
a scheduling cell carrier indicator field, wherein a value configured for the carrier indicator field is associated with the primary cell, or a value configured for the carrier indicator field is associated with another secondary cell that can be cross-carrier scheduled by the secondary cell; and
the method further comprises:
receiving, by the terminal, downlink control information sent by the network side terminal, wherein the downlink control information carries the carrier indicator field; and
determining, by the terminal based on a value of the carrier indicator field carried by the downlink control information and a value configured for the scheduling cell carrier indicator field, whether to cross-carrier schedule, based on the downlink control information, a primary cell or a secondary cell associated with the value configured for the scheduling cell carrier indicator field.

15. A terminal, comprising: a memory storing a computer program; and a processor coupled to the memory and configured to execute the computer program to perform operations comprising:
receiving, by the terminal, first information of a cell group serving the terminal sent by a network side device, wherein the first information comprises:
M pieces of activation or deactivation indication information, wherein the activation or deactivation indication information is used to indicate whether to activate a corresponding secondary cell; and
N pieces of indication information of a temporary reference signal configuration, wherein the indication information of a temporary reference signal configuration is used to indicate the temporary reference signal configuration that is used by the terminal to activate a secondary cell or a secondary cell group; and the secondary cell group comprises one or more secondary cells,
Wherein M is equal to the number of secondary cells that are configured for the terminal, both N and M are integers greater than or equal to 1, and N is less than or equal to M.

16. The terminal according to claim 15, wherein receiving, by the terminal, the first information of the cell group serving the terminal sent by the network side device comprises:
receiving, by the terminal, a media access control control element (MAC CE), wherein the MAC CE carries the first information.

17. The terminal according to claim 15, wherein the operations further comprise:
determining, by the terminal based on displaying and indicating of the MAC CE, the number of bits occupied by one piece of indication information of a temporary reference signal configuration;
determining, by the terminal based on displaying and indicating of first radio resource control (RRC) signaling, the number of bits occupied by one piece of indication information of a temporary reference signal configuration;
determining, by the terminal based on a maximum number of temporary reference signal configurations configured for a secondary cell in first RRC signaling, the number of bits occupied by one piece of indication information of a temporary reference signal configuration; or
determining, by the terminal based on a maximum number of temporary reference signal configurations configured for a secondary cell group in first RRC signaling, the number of bits occupied by one piece of indication information of a temporary reference signal configuration,
wherein the first RRC signaling is used to configure at least one temporary reference signal configuration for the secondary cell or the secondary cell group of the terminal.

18. The terminal according to claim 15, wherein:
a value of N is the same as the number of activated secondary cells;
a value of N is the same as the number of activated secondary cell groups;
a value of N is the same as the number of secondary cells that are configured with a temporary reference signal configuration through second RRC signaling;
a value of N is the same as the number of secondary cell groups that are configured with a temporary reference signal configuration through second RRC signaling; or
a value of N is configured or pre-agreed by the network side device.

19. The terminal according to claim 15, wherein the operations further comprise:
receiving, by the terminal, second information of the cell group serving the terminal sent by a network side device, wherein the second information is used to indicate that a primary cell supports a resource in being self-scheduled and cross-carrier scheduled.

20. A network side device, comprising: a memory storing a computer program; and a processor coupled to the memory and configured to execute the computer program to perform the method according to claim 1.
